(19) United States
(12) Patent Application Publication
(10) Pub. No.: US 2023/0186206 A1
(43) Pub. Date: Jun. 15, 2023

(54) ORDERING FLIGHT TAKEOFFS AND LANDINGS BASED ON PASSENGER COMPLAINT PROPENSITIES

(71) Applicant: INTERNATIONAL BUSINESS MACHINES CORPORATION, ARMONK, NY (US)

(72) Inventors: Herbert Scott McFaddin, Yorktown Heights, NY (US); Youssef Drissi, Peekskill, NY (US); Markus Ettl, Yorktown Heights, NY (US); Anna Lisa Gentile, San Jose, CA (US); Petar Ristoski, San Jose, CA (US); Chek Keong Tan, Danbury, CT (US); Wei Sun, Scarsdale, NY (US)

(21) Appl. No.: 17/644,382

(22) Filed: Dec. 15, 2021

(51) Int. Cl. G06Q 10/06; G06Q 30/02; G06Q 50/14; G06N 5/02

(52) U.S. Cl. CPC G06Q 10/06313; G06Q 30/0206; G06Q 50/14; G06Q 30/0203; G06N 5/022; G06Q 30/0226

(57) ABSTRACT

A computer-implemented method for generating an ordered list of craft departures from a known origin point based on an operational cost and a predicted passenger satisfaction cost. The method collects historical data about one or more passengers, wherein the historical data comprises one or more craft operations and associated passenger complaint and satisfaction data. The method further trains a passenger satisfaction prediction model based on the collected historical data and computes the predicted passenger satisfaction cost for each of the craft departures based on the trained passenger satisfaction prediction model. The method further generates an ordered list of craft departures based on a combination of the operational cost and the computed predicted passenger satisfaction cost.

### BACKGROUND

The present disclosure relates generally to the field of cognitive computing and more particularly to incorporating customer satisfaction in determining departure craft scheduling.

Traditional methods for departure craft scheduling attempt to optimize overall delays or costs associated with craft departures. For example, large airliners may receive priority in takeoffs due to larger passenger counts, or less efficient aircraft may receive priority because of larger fuel burn during idling.

However, travel operators are increasingly focused on customer satisfaction as a key performance indicator when determining departure craft scheduling.

### BRIEF SUMMARY

Embodiments of the present invention disclose a method, a computer program product, and a system.

A computer-implemented method, according to an embodiment of the invention, in a data processing system including a processor and a memory, for generating an ordered list of craft departures from a known origin point based on an operational cost and a predicted customer satisfaction cost. The method includes collecting historical data about one or more customers, wherein the historical data comprises one or more craft operations and associated customer complaint and satisfaction data and training a customer satisfaction prediction model based on the collected historical data. The method further includes computing the predicted customer satisfaction cost for each of the craft departures based on the trained customer satisfaction prediction model and generating the ordered list of craft departures based on a combination of the operational cost and the computed predicted customer satisfaction cost.

A computer program product, according to an embodiment of the invention, includes a non-transitory tangible storage device having program code embodied therewith. The program code is executable by a processor of a computer to perform a method. The method includes collecting historical data about one or more customers, wherein the historical data comprises one or more craft operations and associated customer complaint and satisfaction data and training a customer satisfaction prediction model based on the collected historical data. The method further includes computing the predicted customer satisfaction cost for each of the craft departures based on the trained customer satisfaction prediction model and generating the ordered list of craft departures based on a combination of the operational cost and the computed predicted customer satisfaction cost.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method includes collecting historical data about one or more customers, wherein the historical data comprises one or more craft operations and associated customer complaint and satisfaction data and training a customer satisfaction prediction model based on the collected historical data. The method further includes computing the predicted customer satisfaction cost for each of the craft departures based on the trained customer satisfaction prediction model and generating the ordered list of craft departures based on a combination of the operational cost and the computed predicted customer satisfaction cost.

### BRIEF DESCRIPTION OF THE DRAWINGS

FIG. 1 illustrates a craft departure scheduling environment, in accordance with an embodiment of the present invention.

FIG. 2 is a flowchart illustrating the operation of craft departure scheduling program 120 of FIG. 1, in accordance with an embodiment of the present invention.

FIG. 3 illustrates a use case of craft departure scheduling program 120 of FIG. 1, in accordance with an embodiment of the present invention.

FIG. 4 is a diagram graphically illustrating the hardware components of craft departure scheduling environment of FIG. 1, in accordance with an embodiment of the present invention.

FIG. 5 depicts a cloud computing environment, in accordance with an embodiment of the present invention.

FIG. 6 depicts abstraction model layers of the illustrative cloud computing environment of FIG. 5, in accordance with an embodiment of the present invention.

### DETAILED DESCRIPTION

Nowadays, travel operators (e.g., airlines, ships, buses, trains, etc.) are increasingly focused on customer satisfaction as a key performance indicator. Operational key performance indicators that affect customer satisfaction include but are not limited to: departure time and delay, taxi-out time, in-route time and delays, arrival time and delays, taxi-in time, and induced changes in layovers.

From the travel operator's perspective, travel operators often resort to customer compensations/ameliorations after-the-fact due to failings in operational parameters. In this regard, travel operators expend large amounts of money annually, ranging into hundreds of millions of dollars for such compensations. In many instances it would be a substantial savings in expenditures by avoiding travel situations likely to result in decreased satisfaction and complaints. The avoidance can occur via cost-neutral methods such as choosing alternate departure schedules.

There are three broad opportunities to address customer satisfaction depending upon where the customer is in the travel process: (1) when the customer is making plans and reservations, the travel operator can steer the customer away from potential situations that can reduce customer satisfaction which is oftentimes difficult to predict; (2) when the customer is actually travelling, the travel operator can attempt to improve operations so that situations that reduce satisfaction do not occur; and (3) after the customer has travelled, the travel operator can attempt to improve customer satisfaction by receiving complaints and making compensations, which is oftentimes expensive.

Embodiments of the present invention focus on an artificially intelligence (AI) driven intervention when the customer is travelling, in order for the travel operator to attempt to improve operations so that situations that reduce customer satisfaction are limited.

Travel operators must routinely sequence departures from terminals either due to ordinary operations or exceptional events. For example, rush hour departures at a hub airport must be sequenced due to limited capability of taxi-ways and runways. Or a weather event (e.g., hurricane, heavy winds, snow, etc.) at an airport may cause unanticipated backup departures which results in sequencing the backed-up departures once the weather event subsides.

Traditional methods attempt to prioritize overall delays or costs. For example, large airliners may receive priority in takeoff order due to larger passenger counts, or less efficient aircraft may receive priority in takeoff order due to larger fuel burn during idling, when viewed on a per passenger basis.

The present invention incorporates machine learning models to estimate changes in customer satisfaction due to trip purpose and type factors. For example, research has shown that a delay of flights to vacation destinations will incur a larger number of customer complaints than the same delay applied to business flights.

In order to incorporate machine learning models to estimate changes in customer satisfaction, a travel operator accumulates a history of customer satisfaction values for a set of exemplar departures. In the present invention, the travel operator then trains a satisfaction machine learning model based upon features (“X”) which are a combination of customer, journey, reservations, and operational features of each exemplar departure and a label (“Y”) which is the customer satisfaction value for each exemplar departure. Customer profile and travel history are part of the customer features. Departure delay is one of the operational training features of “X”.

As will be further discussed in relation to the present invention, each query departure is assigned a satisfaction cost function which receives a departure, operational, and delay information as input and then evaluates the satisfaction machine learning model based upon the known customer, journey, reservations, and operational features of the query departure and the provided delay value. Each query departure is evaluated based on a combination of the operational cost function with the customer satisfaction cost function. Thereafter, a requested departure sequencing list is computed based on the combination of operational and satisfaction cost functions and exported to the traffic management system.

As exemplified in the preceding paragraphs, the present invention augments existing departure scheduling capabilities with the ability to incorporate customer satisfaction aspects. Increasing customer satisfaction is an important cost factor, especially in competitive environments.

Historically, scheduling craft departures was based predominantly on fuel costs. Nowadays, customer satisfaction rises in importance with lower fuel prices and engine efficiencies.

A traffic manager, or the one who schedules craft departures, is typically operated by the departure facility (e.g., airport, bus station, train station, etc.) and the travel operator (e.g., specific airline, bus, train, etc.) is constrained to make departure requests of the traffic manager. In other words, the travel operator does not directly determine the final, actual departure sequencing.

Additionally, alternate travel operators often schedule departures from the same origin and compete with each travel operator. The present invention incorporates visibility of scheduled departures of alternate operators but not their exact departure request strategy.

As will be explained in further detail herein, the present invention discloses a novel method that accepts a previously generated requested departure schedule which includes marginal windows of desired departures, applies trained predictive models that predict assigned departures, operational outcomes, and customer satisfaction metrics to generate an improved requested departure schedule. The improved requested departure schedule is then sent to the traffic manager for final scheduling.

Hereinafter, exemplary embodiments of the present invention will be described in detail with reference to the attached drawings.

The present invention is not limited to the exemplary embodiments below but may be implemented with various modifications within the scope of the present invention. In addition, the drawings used herein are for purposes of illustration, and may not show actual dimensions.

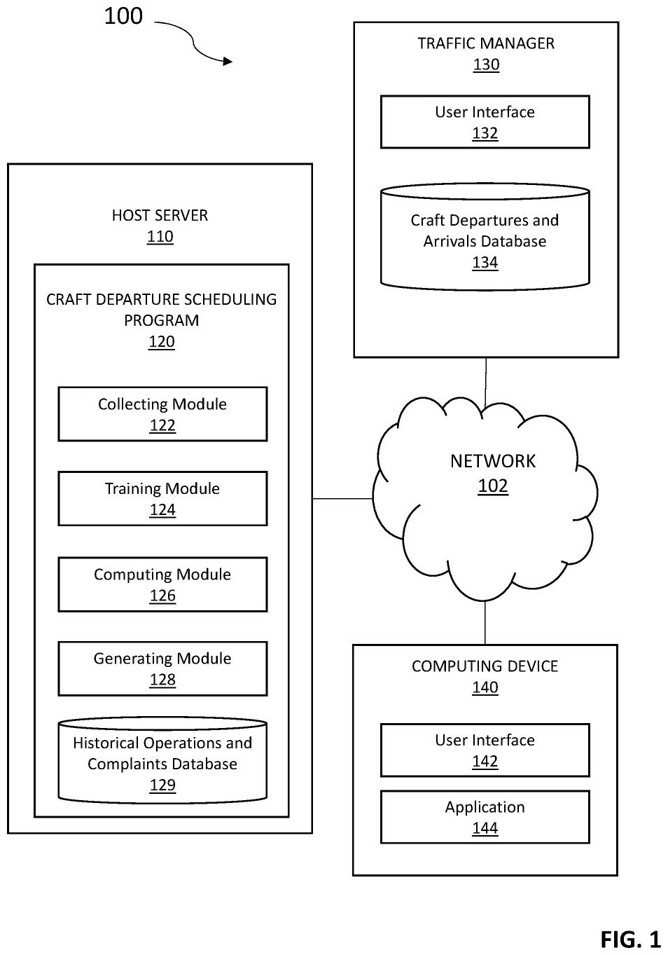

FIG. 1 illustrates craft departure scheduling computing environment 100, in accordance with an embodiment of the present invention. Craft departure scheduling computing environment 100 includes host server 110, traffic manager 130, and computing device 140 all connected via network 102. The setup in FIG. 1 represents an example embodiment configuration for the present invention and is not limited to the depicted setup in order to derive benefit from the present invention.

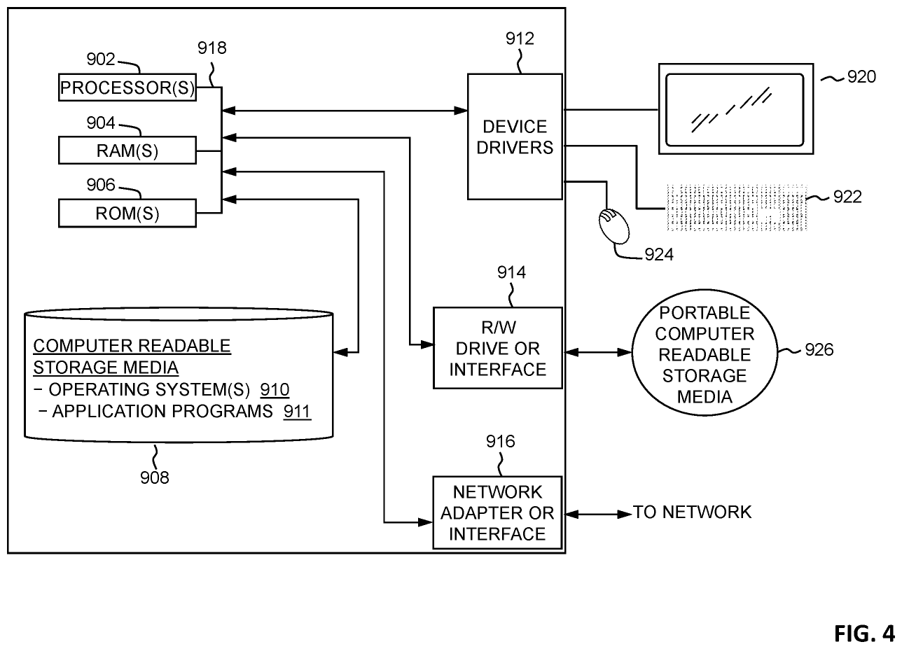

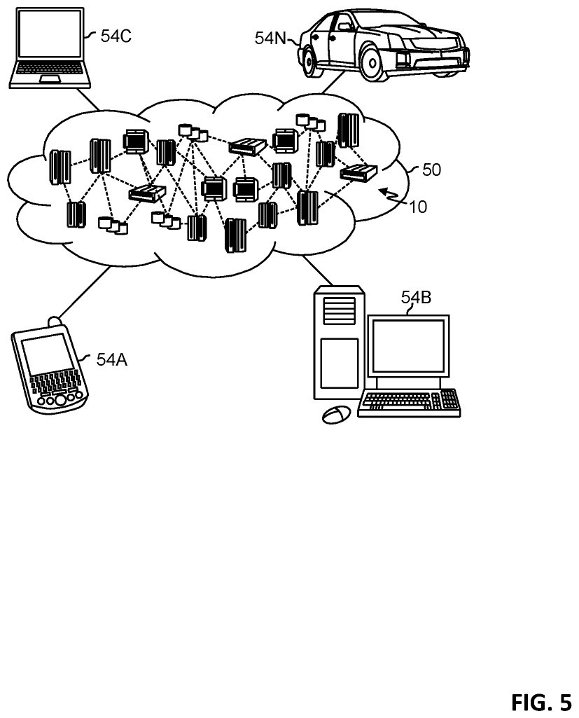

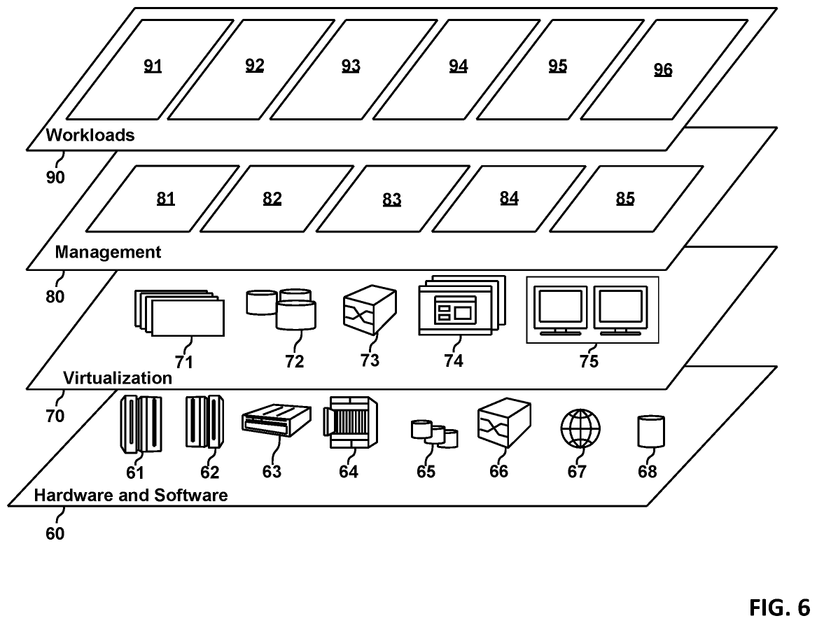

In an exemplary embodiment, host server 110 includes craft departure scheduling program 120. In various embodiments, host server 110 may be a laptop computer, tablet computer, netbook computer, personal computer (PC), a desktop computer, a personal digital assistant (PDA), a smart phone, a server, or any programmable electronic device capable of communicating with traffic manager 130 and computing device 140 via network 102. Host server 110 may include internal and external hardware components, as depicted and described in further detail below with reference to FIG. 4. In other embodiments, host server 110 may be implemented in a cloud computing environment, as described in relation to FIGS. 5 and 6, herein. Host server 110 may also have wireless connectivity capabilities allowing it to communicate with traffic manager 130, computing device 140, and other computers or servers over network 102.

With continued reference to FIG. 1, traffic manager 130 includes user interface 132 and craft departures and arrivals database 134. In exemplary embodiments, traffic manager 130 may be an air traffic control tower that manages airplane departures and arrivals, a bus terminal scheduler of bus departures and arrivals, a train station scheduler of train departures and arrivals, and so forth.

In an exemplary embodiment, traffic manager 130 includes user interface 132, which may be a computer program that allows a user (i.e., the traffic manager) to interact with craft departures and arrivals database 134 and other connected devices via network 102. For example, user interface 132 may be a graphical user interface (GUI). In addition to comprising a computer program, user interface 132 may be connectively coupled to hardware components, such as those depicted in FIG. 4, for sending and receiving data. In an exemplary embodiment, user interface 132 may be a web browser, however in other embodiments user interface 132 may be a different program capable of receiving user interaction and communicating with other devices, such as host server 110.

In exemplary embodiments, user interface 132 may be a touch screen display, a visual display, a remote operated display, or a display that receives input from a physical keyboard. In alternative embodiments, user interface 132 may be operated via voice commands, BLUETOOTH, a mobile device that connects to traffic manager 130, or by any other means known to one of ordinary skill in the art. In exemplary embodiments, a user (i.e. traffic manager 130) may interact with user interface 132 to report a problem, override a scheduled departure or arrival, and receive scheduling changes from craft departure scheduling program 120. In various embodiments, a user may interact with user interface 132 to provide feedback to craft departure scheduling program 120, via network 102.

In an exemplary embodiment, traffic manager 130 includes craft departures and arrivals database 134. Craft departures and arrivals database 134 may be local data storage on traffic manager 130 that contains one or more sets of scheduled craft departures and arrivals data that correspond to various travel operators, locations, times, days of the week, origin, destination, operational features of the craft, and so forth. For example, flight A is departing from New York LaGuardia airport (LGA) at 9:30 am on Monday May 5, 2019 and is scheduled to arrive in Atlanta airport (ATL) at 12:15 pm on the same day. This data set example may be stored in craft departures and arrivals database 134 as data objects, such as <flight_A, LGA, ATL, 9:30 am-12:15 μm, 5/5/19>.

While craft departures and arrivals database 134 is depicted as being stored on traffic manager 130, in other embodiments, craft departures and arrivals database 134 may be stored on host server 110, craft departure scheduling program 120, or any other device or database connected via network 102, as a separate database. In alternative embodiments, craft departures and arrivals database 134 may be comprised of a cluster or plurality of computing devices, working together or working separately.

With continued reference to FIG. 1, computing device 140 includes user interface 142 and application 144. In various embodiments, computing device 140 may be a laptop computer, tablet computer, netbook computer, personal computer (PC), a desktop computer, a personal digital assistant (PDA), a wearable device, a smart phone, or any programmable electronic device capable of communicating with host server 110 and traffic manager 130 via network 102. Computing device 140 may include internal and external hardware components, as depicted and described in further detail below with reference to FIG. 4. In other embodiments, computing device 140 may be implemented in a cloud computing environment, as described in relation to FIGS. 5 and 6, herein. Computing device 140 may also have wireless connectivity capabilities allowing it to communicate with host server 110, traffic manager 130, and other computers or servers over network 102.

In exemplary embodiments, computing device 140 includes user interface 142, which may be a computer program that allows a user to interact with computing device 140 and other connected devices via network 102. For example, user interface 142 may be a graphical user interface (GUI). In addition to comprising a computer program, user interface 142 may be connectively coupled to hardware components, such as those depicted in FIG. 4, for receiving user input. In an exemplary embodiment, user interface 142 may be a web browser, however in other embodiments user interface 142 may be a different program capable of receiving user interaction and communicating with other devices.

In exemplary embodiments, computing device 140 includes application 144, which may be a computer program, on computing device 140, that allows a user to post feedback, reviews, and satisfaction level of the service received for any given travel operator in real-time. In exemplary embodiments, application 144 may be a social media website, a travel operator's website, an online discussion board, or any such application that permits an end user to communicate feedback concerning a travel experience.

With continued reference to FIG. 1, craft departure scheduling program 120, in the exemplary embodiment, may be a computer application on host server 110 that contains instruction sets, executable by a processor. The instruction sets may be described using a set of functional modules. In exemplary embodiments, craft departure scheduling program 120 may receive input from traffic manager 130 and computing device 140 over network 102. In alternative embodiments, craft departure scheduling program 120 may be a computer application contained within traffic manager 130, or as a standalone program on a separate electronic device.

With continued reference to FIG. 1, the functional modules of craft departure scheduling program 120 include collecting module 122, training module 124, computing module 126, generating module 127, communicating module 128 and historical operations and complaints database 129.

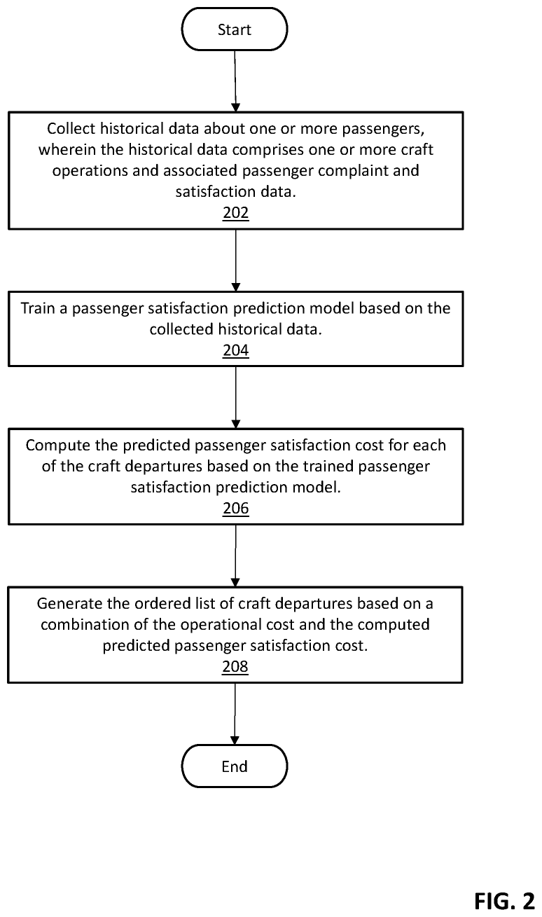

FIG. 2 is a flowchart illustrating the operation of craft departure scheduling program 120 of FIG. 1, in accordance with embodiments of the present invention.

With reference to FIGS. 1 and 2, collecting module 122 includes a set of programming instructions in craft departure scheduling program 120, to collect historical data about one or more customers, wherein the historical data comprises one or more craft operations and associated customer complaint and satisfaction data (step 202). The set of programming instructions is executable by a processor.

In exemplary embodiments, historical data about one or more craft operations and associated customer complaint and satisfaction data may include a collection of data points with reference to a user's (i.e., customer/passenger) previous departures and experiences with travel operators.

There are a variety of object measures of customer complaint and satisfaction data against which the customer satisfaction prediction model, discussed herein, may be trained. For example, some object measures may include a count of customer complaints, direct customer surveys and feedback mechanisms, and propensities for follow-on travel with the travel operator.

In exemplary embodiments, a history of customer satisfaction values are collected, via collecting module 122, over time for a set of exemplar departures. A satisfaction machine learning model may be based upon features (“X”) which are a combination of aggregated customer, route, reservations, and operational features of each exemplary departure and an associated label (“Y”), which is the customer satisfaction value for each exemplary departure.

In exemplary embodiments, aggregated customer profiles (i.e., the percent of loyalty members on a flight) are a part of the customer features. Departure time, arrival time, taxi time, and in-route delays are a part of the operational training features in “X”.

In exemplary embodiments, collecting module 122 may be capable of obtaining craft operations of a travel operator and associated customer complaint and satisfaction data of one or more customers by at least one of the following: video cameras, internet of things (IoT) devices, IoT sensors, traffic manager 130, and personal computing devices of the one or more customers (e.g., computing device 140), via network 102.

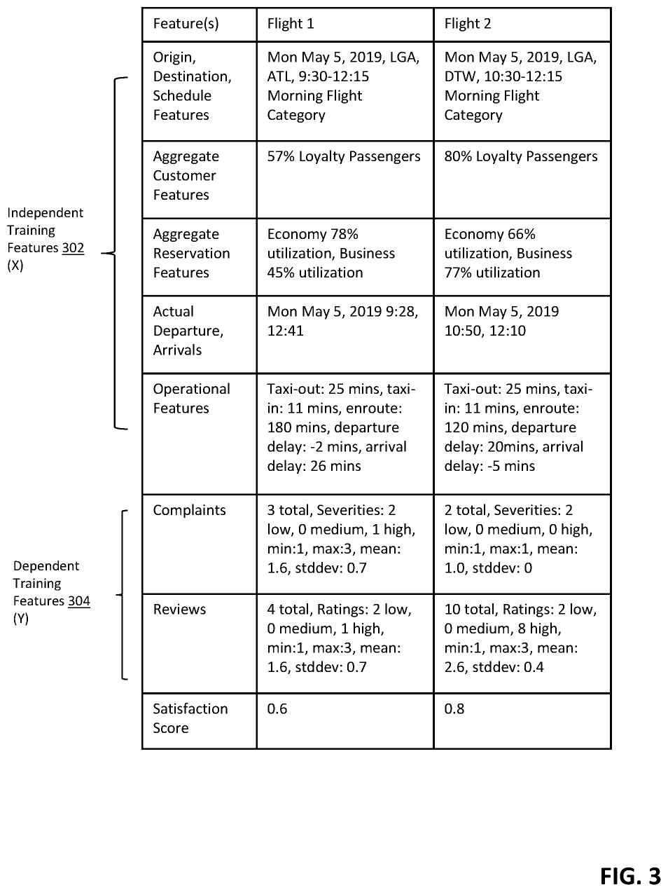

FIG. 3 illustrates a use case of craft departure scheduling program 120 of FIG. 1, in accordance with an embodiment of the present invention.

With reference to FIG. 3 and an illustrative example, the independent training features 302 (′X″) for two sample flights (Flight 1 and Flight 2) include “Origin, Destination, Schedule Features”, “Aggregate Customer Features”, Aggregate Reservation Features”, “Actual Expected Departure and Arrival Times”, and “Operational Features”. The dependent training features 304 (“Y”) for the same two sample flights (Flight 1 and Flight 2) include “Complaints” and “Reviews”. Collecting module 122 collects the historical data of craft operations for Flight 1 and Flight 2, together with customer satisfaction data for the respective flights.

In exemplary embodiments, collecting module 122 may archive the received sets of craft operations data and associated customer complaint and satisfaction data, in historical operations and complaints database 129. Historical operations and complaints database 129 may be local data storage on craft departure scheduling program 120.

In exemplary embodiments, craft departure scheduling program 120 may be capable of building a data profile for the one or more customers and dynamically updating the respective data profile when associated customer complaint and/or satisfaction data is received.

While historical operations and complaints database 129 is depicted as being stored on craft departure scheduling program 120, in other embodiments, historical operations and complaints database 129 may be stored on host server 110, traffic manager 130, or any other device or database connected via network 102, as a separate database. In alternative embodiments, historical operations and complaints database 129 may be comprised of a cluster or plurality of computing devices, working together or working separately.

With continued reference to FIGS. 1 and 2, training module 124 includes a set of programming instructions in craft departure scheduling program 120, to train a customer satisfaction prediction model based on the collected historical data (step 204). The set of programming instructions is executable by a processor.

In exemplary embodiments, training module 124 uses historical data about customers and flight operations as input data and customer complaints/satisfaction as target data.

For example, craft departure scheduling program 120 may estimate a customer satisfaction score for a test departure feature set. The customer satisfaction score estimate is based on examination of the historical data of previous departures.

In exemplary embodiments, training module 124 incorporates an estimate of operational parameters of a departure and given a prospective assigned departure window predicted from a prospective test variation. The operational parameters may include, but are not limited to, taxi-out time or other similar staging factors, travel time (e.g., flight time), arrival time, and taxi-in or other similar de-staging factors at the destination terminal.

In exemplary embodiments, operational parameters may be estimated in a variety of ways. For example, operational parameters may be estimated by examination of average taxi or staging times, to more sophisticated analyses which consider in-route factors such as air traffic control and weather (e.g., taxi times can be modelled against time of day, day of week, market conditions, etc.).

Further, the prospective departure is combined with the anticipated operational parameters, fixed operational parameters, plus a variety of departure features, craft features, aggregated customer features (e.g., the percentage of customers who are loyalty members), aggregated reservation features (e.g., loading/crowding per cabin class), route features, origin features, and destination features in order to create a test departure feature set.

The estimated customer satisfaction score may, for example, be calculated via trained machine learning models or deep learning models (e.g., artificial neural network). There are a variety of possibilities for models. Models may include, but are not limited to, linear regression, logistic regression, decision trees, random forests, gradient boosted decision trees, etc.

In exemplary embodiments, training module 124 can be integrated with existing decision logic for scheduling departure sequence requests. For example, existing decision logic is used to calculate the initial departure windows for a specific craft. The logic of craft departure scheduling program 120 is then used within the calculated initial departure windows, for a specific craft, to generate narrower, more highly optimized departure sequence requests.

In alternative embodiments, each query departure can be assigned a satisfaction cost function which receives a departure, as input, and then evaluates the satisfaction machine learning model based upon lookups of customer data, journey, reservations, and predictions of operational features of the query departure. Each query departure may then be assigned an extended cost function which combines a pre-existing operational cost function, based on prior models, with the new satisfaction cost function. The combination may be based on weighting values or an alternate functional combination.

In alternative embodiments, a requested departure sequencing list can be computed based on substitution of the extended cost functions into pre-existing departure planning logic, and then exported to traffic manager 130.

With continued reference to FIG. 3 and the illustrative example above, training module 124 trains a customer satisfaction prediction model based on two prior departures from LaGuardia airport (LGA) on a Monday morning: An Atlanta flight (ATL) and a Detroit flight (DTW). The DTW flight shows a higher delay but better satisfaction scores (i.e., fewer complaints and higher reviews), and has a greater percentage of loyalty customers. As such, training module 124 highlights which flights may be sequenced before or after scheduled departures and retain customer satisfaction.

With continued reference to FIGS. 1 and 2, computing module 126 includes a set of programming instructions in craft departure scheduling program 120, to compute the predicted customer satisfaction cost for each of the craft departures based on the trained customer satisfaction prediction model (step 206). The set of programming instructions is executable by a processor.

In exemplary embodiments, craft departure scheduling program 120 receives collected historical data, including craft operations and associated customer complaint and satisfaction data, wherein the collected historical data includes a combination of aggregated customer profile information, aggregated travel reservation information, aggregated origin and destination information, and departing craft and route information, together with a label that indicates the associated customer complaint and satisfaction value for each of the craft departures.

In exemplary embodiments, the customer complaint value includes a measure of aggregated complaint severity values based on customer feedback comprising a mean value, a maximum value, a minimum value, and wherein a severity value within a predetermined range is assigned to the customer complaint value in correlation to a specific prior departure.

In exemplary embodiments, aggregated customer profile information consists of a number of passengers travelling on a prior departure for which a known travel purpose is assigned (e.g., business, vacation, or discretionary travel), a number of passengers travelling on a prior departure who are associated with one or more loyalty categories, and a number of passengers travelling on a departure who fall within one or more predetermined categories of travel experience and loyalty program tenure.

In exemplary embodiments, aggregated travel reservation features may include a number of booking concentrations per cabin class (e.g., business class, first class, economy, etc.).

In exemplary embodiments, departing craft and route features may include the craft model, size, capacity, utilization, and so forth.

In exemplary embodiments, computing module 126 may estimate an anticipated actual assigned departure time window comprising a minimum departure time window and a maximum anticipated departure time window. For example, computing module 126 may compute the average delay offset for a day of the week, a time of the day, the departure terminal, and the arrival terminal over a 30-, 60-, or 90-day time window. Computing module 126 may then set an anticipated actual assigned departure time window, which is the requested departure time plus, or minus, the computed average delay offset.

In alternative embodiments, computing module 126 may incorporate weather forecasts and other additional features as inputs to machine learning algorithms. For example, computing module 126 may incorporate anticipated departure schedule requests of alternate travel operators based on known (e.g., public information) departure schedules.

In exemplary embodiments, computing module 126 is further capable of estimating an additional set of dependent operational features for the craft departure. The additional set of dependent operational features include but are not limited to a taxi-out time, a travel time, an arrival taxi-in time, and an arrival time.

Furthermore, computing module 126 then merges with the estimated anticipated actual assigned departure time window and the estimated dependent operational features for the departure, the scheduled departure and arrival times, the received aggregated customer profile information, the received aggregated travel reservation information, the received aggregated origin and destination information, and the received departing craft and route information.

In exemplary embodiments, computing module 126 receives aggregated customer survey information in relation to one or more specific prior departures, and computes an aggregated customer satisfaction value for each prospective departure, wherein the computing is based on the received aggregated customer survey information. Computing module 126 then determines a best prospective departure request schedule based on the computed aggregated customer satisfaction value for each of the prospective departures and transmits the determined best prospective departure request schedule to a traffic manager for scheduling the received departures.

In exemplary embodiments, a best prospective departure request scheduled is based on the highest computed aggregated customer satisfaction value compared to other prospective departures.

In exemplary embodiments, the computed aggregate customer satisfaction value for each prospective departure is made by a supervised machine learning model trained against a training set of labelled prior departure values, aggregated customer profile information, and associated aggregated customer satisfaction values made against a corpus of prior departures.

Aggregated customer satisfaction values may be made based upon receiving aggregated customer complaint information in which the customer complaint information is made in correlation with specific prior departures. Further, in exemplary embodiments, aggregated customer complaint information includes a count of customer complaints received for specific prior departures.

In alternative embodiments, aggregated customer complaint information includes a measure of an aggregated compensation amount made to the customers, by the travel operator, in response to a complaint correlated with a prior departure, wherein the aggregated compensation amount includes a mean amount, a maximum amount, a minimum amount, or a variance of amounts where the compensation amount is assigned to a customer complaint in correlation to a specific prior departure.

With continued reference to FIG. 3 and the illustrative example above, computing module 126 estimates a customer satisfaction value based on the various input data (i.e., origin and destination features, aggregated customer features, aggregated reservation features, actual departure and arrival schedule, operational features, and customer complaints and reviews. As seen in the table of FIG. 3, the DTW flight shows a higher delay (20 minutes delay) than the ATL flight (2 minutes delay). However, the DTW shows better satisfaction scores amongst its customers (i.e., fewer complaints and higher reviews). The DTW flight also shows a greater percentage of loyalty customers (80% loyalty passengers) over the ATL flight (57% loyalty customers). When the customer satisfaction prediction model is subsequently evaluated against similar flight options, morning flights to DTW with higher loyalty customer counts will tend to predict higher customer satisfaction, even when there is a higher delay.

With continued reference to FIGS. 1 and 2, generating module 128 includes a set of programming instructions in craft departure scheduling program 120, to generate an ordered list of craft departures based on a combination of the operational cost and the computed predicted customer satisfaction cost (step 208). The set of programming instructions is executable by a processor.

In exemplary embodiments, craft departure scheduling program 120 receives a request to generate an ordered list of craft departures, wherein the ordered list of craft departures includes a set of departing craft with associated scheduled departure and arrival times, and a departure time window for each of the craft departures.

In exemplary embodiments, generating module 128 generates a set of prospective test requested departure schedules which explore a space of variations for prospective departures. This exploration may be generated in various ways ranging from a grid search, which explores all potential departure sub-windows up to a given granularity, to a gradient style search, which explores based on direct of most rapid improvement.

Generating module 128 can generate a list of prospective departure request schedules that include the given set of departing craft and, for each departing craft, a requested departure time window comprising a minimum requested departure time and a maximum requested departure time.

In exemplary embodiments, craft departure scheduling program 120 accepts a previously generated requested departure schedule, which includes marginal windows of desired departures, applies the trained predictive models which predict assigned departure, operational outcomes and customer satisfaction metrics to generate, via generating module 128, an improved requested departure schedule. The improved requested departure schedule is then sent to traffic manager 130, over network 102, for final scheduling.

With continued reference to FIG. 3 and the illustrative example above, since the travel operator wishes to improve a departure schedule request, generating module 128 would generate an ordered list of craft departures placing DTW flights later in a requested sequence since the customer satisfaction prediction model shows that higher delays for the DTW flights do not impact satisfaction scores, especially if the flights are populated by loyalty customers.

In an exemplary embodiment, network 102 is a communication channel capable of transferring data between connected devices and may be a telecommunications network used to facilitate telephone calls between two or more parties comprising a landline network, a wireless network, a closed network, a satellite network, or any combination thereof. In another embodiment, network 102 may be the Internet, representing a worldwide collection of networks and gateways to support communications between devices connected to the Internet. In this other embodiment, network 102 may include, for example, wired, wireless, or fiber optic connections which may be implemented as an intranet network, a local area network (LAN), a wide area network (WAN), or any combination thereof. In further embodiments, network 102 may be a Bluetooth network, a WiFi network, or a combination thereof. In general, network 102 can be any combination of connections and protocols that will support communications between host server 110, traffic manager 130, and computing device 140.

FIG. 4 is a block diagram depicting components of a computing device (such as host server 110 or computing device 140, as shown in FIG. 1), in accordance with an embodiment of the present invention. It should be appreciated that FIG. 4 provides only an illustration of one implementation and does not imply any limitations regarding the environments in which different embodiments may be implemented. Many modifications to the depicted environment may be made.

Host server 110 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as craft departure scheduling program 120, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Host server 110 may also include a RAY drive or interface 914 to read from and write to one or more portable computer readable storage media 926. Application programs 911 on host server 110 may be stored on one or more of the portable computer readable storage media 926, read via the respective R/W drive or interface 914 and loaded into the respective computer readable storage media 908.

Host server 110 may also include a network adapter or interface 916, such as a TCP/IP adapter card or wireless communication adapter (such as a 4G wireless communication adapter using OFDMA technology). Application programs 911 on host server 110 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Host server 110 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and controlling access to data objects 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present invention. Therefore, the present invention has been disclosed by way of example and not limitation.

What is claimed is:

1. A computer-implemented method for generating an ordered list of craft departures from a known origin point based on an operational cost and a predicted customer satisfaction cost, the method comprising:
collecting historical data about one or more customers, wherein the historical data comprises one or more craft operations and associated customer complaint and satisfaction data;
training a customer satisfaction prediction model based on the collected historical data;
computing a predicted customer satisfaction cost for each of the craft departures based on the trained customer satisfaction prediction model; and
generating an ordered list of craft departures based on a combination of the operational cost and the computed predicted customer satisfaction cost.

2. The computer-implemented method of claim 1, further comprising:
receiving a request to generate the ordered list of craft departures, wherein the ordered list of craft departures includes a set of departing craft with associated scheduled departure and arrival times, and a departure time window for each of the craft departures.

3. The computer-implemented method of claim 1, further comprising:
receiving collected historical data, including craft operations and associated customer complaint and satisfaction data, wherein the collected historical data includes a combination of aggregated customer profile features, aggregated travel reservation features, aggregated origin and destination features, and departing craft and route features, together with a label that indicates the associated customer complaint and satisfaction value for each of the craft departures.

4. The computer-implemented method of claim 3, wherein computing the predicted customer satisfaction cost for each of the craft departures based on the trained customer satisfaction prediction model further comprises:
receiving aggregated customer survey information in relation to one or more specific prior departures;
computing an aggregate customer satisfaction value for each prospective departure, wherein the computing is based on the received aggregated customer survey information;
determining a best prospective departure request schedule based on the computed aggregated customer satisfaction value for each of the prospective departures; and
transmitting the determined best prospective departure request schedule to a traffic manager for scheduling the received departures.

5. The computer-implemented method of claim 4, further comprising:
estimating an anticipated actual assigned departure time window comprising a minimum anticipated departure time window and a maximum anticipated departure time window;
further estimating, from the anticipated actual assigned departure time window, an additional set of dependent operational features for the departure, wherein the additional set of dependent operational features include a departure taxi-out time, a travel time, an arrival taxi-in time, and an arrival time; and
merging with the estimated anticipated actual assigned departure time window and the estimated dependent operational features for the departure, the scheduled departure and arrival times, the received aggregated customer profile features, the received aggregated travel reservation features, the received aggregated origin and destination features, and the received departing craft and route features.

6. The computer-implemented method of claim 3, wherein the customer complaint value comprises a measure of aggregated complaint severity values based on customer feedback comprising a mean value, a maximum value, a minimum value, and wherein a severity value within a predetermined range is assigned to the customer complaint value in correlation to a specific prior departure.

7. The computer-implemented method of claim 6, wherein the computed aggregate customer satisfaction value for each prospective departure is made by a supervised machine learning model trained against a training set of labelled prior departure values, aggregated customer profile information, and associated aggregate customer satisfaction values made against a corpus of prior departures.

8. The computer-implemented method of claim 7, wherein the aggregated customer profile information consists of: a number of passengers travelling on a prior departure for which a known travel purpose is assigned, a number of passengers travelling on a prior departure who are associated with one or more loyalty categories, and a number of passengers travelling on a departure who fall within one or more predetermined categories of travel experience and loyalty program tenure.

9. A computer program product, comprising a tangible storage device having program code embodied therewith, the program code executable by a processor of a computer to perform a method, the method comprising:
collecting historical data about one or more customers, wherein the historical data comprises one or more craft operations and associated customer complaint and satisfaction data;
training a customer satisfaction prediction model based on the collected historical data;
computing a predicted customer satisfaction cost for each of the craft departures based on the trained customer satisfaction prediction model; and
generating an ordered list of craft departures based on a combination of the operational cost and the computed predicted customer satisfaction cost.

10. The computer program product of claim 9, further comprising:
receiving a request to generate the ordered list of craft departures, wherein the ordered list of craft departures includes a set of departing craft with associated scheduled departure and arrival times, and a departure time window for each of the craft departures.

11. The computer program product of claim 9, further comprising:
receiving collected historical data, including craft operations and associated customer complaint and satisfaction data, wherein the collected historical data includes a combination of aggregated customer profile features, aggregated travel reservation features, aggregated origin and destination features, and departing craft and route features, together with a label that indicates the associated customer complaint and satisfaction value for each of the craft departures.

12. The computer program product of claim 11, wherein computing the predicted customer satisfaction cost for each of the craft departures based on the trained customer satisfaction prediction model further comprises:
receiving aggregated customer survey information in relation to one or more specific prior departures;
computing an aggregate customer satisfaction value for each prospective departure, wherein the computing is based on the received aggregated customer survey information;
determining a best prospective departure request schedule based on the computed aggregated customer satisfaction value for each of the prospective departures; and
transmitting the determined best prospective departure request schedule to a traffic manager for scheduling the received departures.

13. The computer program product of claim 12, further comprising:
estimating an anticipated actual assigned departure time window comprising a minimum anticipated departure time window and a maximum anticipated departure time window;
further estimating, from the anticipated actual assigned departure time window, an additional set of dependent operational features for the departure, wherein the additional set of dependent operational features include a departure taxi-out time, a travel time, an arrival taxi-in time, and an arrival time; and
merging with the estimated anticipated actual assigned departure time window and the estimated dependent operational features for the departure, the scheduled departure and arrival times, the received aggregated customer profile features, the received aggregated travel reservation features, the received aggregated origin and destination features, and the received departing craft and route features.

14. The computer program product of claim 11, wherein the customer complaint value comprises a measure of aggregated complaint severity values based on customer feedback comprising a mean value, a maximum value, a minimum value, and wherein a severity value within a predetermined range is assigned to the customer complaint value in correlation to a specific prior departure.

15. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
collecting historical data about one or more customers, wherein the historical data comprises one or more craft operations and associated customer complaint and satisfaction data;
training a customer satisfaction prediction model based on the collected historical data;
computing a predicted customer satisfaction cost for each of the craft departures based on the trained customer satisfaction prediction model; and
generating an ordered list of craft departures based on a combination of the operational cost and the computed predicted customer satisfaction cost.

16. The computer system of claim 15, further comprising:
receiving a request to generate the ordered list of craft departures, wherein the ordered list of craft departures includes a set of departing craft with associated scheduled departure and arrival times, and a departure time window for each of the craft departures.

17. The computer system of claim 15, further comprising:
receiving collected historical data, including craft operations and associated customer complaint and satisfaction data, wherein the collected historical data includes a combination of aggregated customer profile features, aggregated travel reservation features, aggregated origin and destination features, and departing craft and route features, together with a label that indicates the associated customer complaint and satisfaction value for each of the craft departures.

18. The computer system of claim 17, wherein computing the predicted customer satisfaction cost for each of the craft departures based on the trained customer satisfaction prediction model further comprises:
receiving aggregated customer survey information in relation to one or more specific prior departures;
computing an aggregate customer satisfaction value for each prospective departure, wherein the computing is based on the received aggregated customer survey information;
determining a best prospective departure request schedule based on the computed aggregated customer satisfaction value for each of the prospective departures; and
transmitting the determined best prospective departure request schedule to a traffic manager for scheduling the received departures.

19. The computer system of claim 18, further comprising:
estimating an anticipated actual assigned departure time window comprising a minimum anticipated departure time window and a maximum anticipated departure time window;
further estimating, from the anticipated actual assigned departure time window, an additional set of dependent operational features for the departure, wherein the additional set of dependent operational features include a departure taxi-out time, a travel time, an arrival taxi-in time, and an arrival time; and
merging with the estimated anticipated actual assigned departure time window and the estimated dependent operational features for the departure, the scheduled departure and arrival times, the received aggregated customer profile features, the received aggregated travel reservation features, the received aggregated origin and destination features, and the received departing craft and route features.

20. The computer system of claim 17, wherein the customer complaint value comprises a measure of aggregated complaint severity values based on customer feedback comprising a mean value, a maximum value, a minimum value, and wherein a severity value within a predetermined range is assigned to the customer complaint value in correlation to a specific prior departure.
